(19) United States
(12) Patent Application Publication
(10) Pub. No.: US 2022/0247273 A1
(43) Pub. Date: Aug. 4, 2022

(54) ELECTRIC MACHINE

(71) Applicant: Schaeffler Technologies AG & Co. KG, Herzogenaurach (DE)

(72) Inventors: Patrick GRAMANN, Renchen (DE); Nicolai GRAMANN, Renchen (DE)

(73) Assignee: Schaeffler Technologies AG & Co. KG, Herzogenaurach (DE)

(21) Appl. No.: 17/613,559

(22) PCT Filed: May 4, 2020
(86) PCT No.: PCT/DE2020/100364

§ 371 Date: Nov. 23, 2021

(30) Foreign Application Priority Data
May 24, 2019 (DE) 10 2019 113 950.3

(51) Int. Cl. H02K 9/197; H02K 5/20; H02K 3/24; H02K 1/20

(52) U.S. Cl. CPC H02K 9/197; H02K 1/20; H02K 3/24; H02K 5/20

(57) ABSTRACT

An electric machine including a stator having a laminated core and windings, in which a winding head, which is formed by the windings, projects at axial ends of the laminated core in the axial direction beyond the laminated core. A rotor is rotatably mounted in the stator, and the rotor includes a rotor body and a shaft on which the rotor body is fastened. A cooling device is provided for cooling the electric machine with a coolant, and the cooling device is designed to convey the coolant from the shaft towards the winding heads and thus to cool the winding heads. Preferably, the cooling device is also designed to spray the coolant from the shaft towards the winding heads in order to cool the winding heads.

### CROSS-REFERENCE TO RELATED APPLICATIONS

This application is the U.S. National Phase of PCT Appln. No. PCT/DE2020/100364, filed May 4, 2020, which claims priority from German Patent Application No. 10 2019 113 950.3, filed May 24, 2019, the entire disclosures of which are incorporated by reference herein.

### TECHNICAL FIELD

The disclosure relates to an electric machine with a stator and a rotor and a cooling device for cooling the winding heads of the stator.

### BACKGROUND

It is known that electric machines have to be cooled in order to increase their efficiency since the ohmic losses decrease at low temperatures.

Furthermore, temperature-sensitive components are built into an electric machine, for example rotor magnets that become demagnetized at high temperatures.

Also, depending on the manufacturing process, for example, baking varnish must also be considered a critical, temperature-sensitive component.

In order to avoid temperature peaks, known electric machines are cooled with oil.

However, these machines are designed in such a way that the hotspots to be cooled are not necessarily reached and local overheating still occurs.

### SUMMARY

It is therefore the object of the present disclosure to specify an electric machine which inexpensively ensures improved cooling of the electric machine.

According to the disclosure, this object is achieved by one or more of the features described herein.

According to the present disclosure, an electric machine comprises:
a stator with a laminated core and windings,
wherein at the axial ends of the laminated core, a respective winding head, formed by the windings, protrudes beyond the laminated core in the axial direction, and
a rotor which is rotatably mounted in the stator,
wherein the rotor comprises a rotor body and a shaft on which the rotor body is fastened.

The electric machine preferably comprises a cooling device for cooling the electric machine by means of a coolant, the cooling device preferably being configured to convey the coolant from the shaft in the direction of the winding heads and thus to cool the winding heads.

Furthermore, it is preferred that the cooling device is configured to fling or spray the coolant from the shaft in the direction of the winding heads in order to cool the winding heads. In this way, a spray mist can be created that exchanges heat on the largest possible surface area of the winding heads in order to cool them.

The cooling device is preferably configured to guide or to fling or to spray the coolant in the radial and/or axial direction to the winding heads in order to cool them. A larger amount of coolant can thus be delivered in a targeted manner in a predetermined direction.

The cooling device expediently comprises the shaft, which is designed as a hollow shaft for conveying coolant. A coolant can thus be transported within the shaft, which reduces the structural complexity for pipes.

It is also expedient if the cooling device has at least one passage in the wall of the shaft, so that coolant can be conveyed from the interior of the shaft through the wall of the shaft.

The at least one passage is preferably designed to generate a spray mist. In this way, the largest possible cooling surface for the coolant can be generated.

The cooling device advantageously has two or more passages which are distributed or offset in the circumferential direction of the shaft. It is advantageous here if, for example, two passages are arranged offset from one another by 90 degrees in the circumferential direction.

In addition or as an alternative, it is also advantageous if the cooling device has two or more passages which are arranged one after the other in the axial direction.

Furthermore, it is advantageous if the at least one passage is designed as a nozzle, in particular in the wall of the shaft. A spray mist can thus be generated in a simple manner.

The at least one passage is advantageously oriented in the radial and/or axial direction in the wall of the shaft. In other words, it is advantageous if the at least one passage is designed to be inclined, in particular in the radial direction. This makes it possible to concentrate coolant at certain points by, for example, orienting the at least one passage in a corresponding direction.

The cooling device preferably has at least one coolant guide, which guides the coolant from the shaft in the radial direction and/or in the axial direction to the winding heads. In this way, coolant can be guided in a concentrated manner to certain points with, for example, a high level of heat generation.

Furthermore, it is preferred that a first coolant guide of the cooling device guides the coolant from the shaft, in particular exclusively, in the radial direction to the winding heads. In this way, it is possible to cool a specific section of the winding heads or only the winding heads on a surface oriented radially inward.

A second coolant guide of the cooling device preferably guides the coolant from the shaft to the winding heads first in the radial direction and then in the axial direction. It is thus possible to cool an axial end face of the winding heads.

A first coolant guide of the cooling device expediently comprises a first and a second guide part, which extend in the radial direction and guide coolant from the shaft to an inner jacket surface of the winding heads. In this way, a radially inwardly oriented surface of the winding heads can be cooled.

It is also advantageous if the first and second guide parts run in a straight line from the shaft to the winding heads, and in particular are each designed as a sheet metal disc.

It is also possible for the winding heads to form a hollow cylindrical shape at one axial end of the stator.

The hollow cylindrical shape preferably has an inner and an outer jacket surface and an axial end face which is directed outwardly away from the electric machine.

The first and second guide parts advantageously form a first cooling chamber which limits the application of coolant to the winding heads.

It is also advantageous if the first guide part shields the air gap between the rotor and stator in order to prevent the intrusion of coolant into the air gap. This is because the ingress of coolant into the air gap can reduce the efficiency of the electric machine.

Furthermore, it is advantageous if the first guide part extends in the radial direction from the shaft to an inner jacket surface of the winding heads.

It is also possible for the second guide part to terminate in the axial direction with the axial end of the winding heads so that coolant can be guided from the shaft, in particular exclusively, to an inner jacket surface of the winding heads.

Furthermore, it can be provided that a second coolant guide of the cooling device comprises a second and a third guide part, which extend partly in the radial direction and partly in the axial direction and guide coolant from the shaft to an axial end face of the winding heads.

The second guide part preferably runs in a straight line from the shaft to the winding heads, and is designed in particular as a sheet metal disc.

It is also possible for the second guide part to terminate in the axial direction with the axial end of the winding heads so that coolant can be guided from the shaft, in particular exclusively, to an axial end face of the winding heads.

The second and third guide parts preferably form a second cooling chamber which limits the application of coolant to the winding heads.

It is also preferred that the second guide part extends in the radial direction from the shaft to an inner jacket surface of the winding heads.

Furthermore, it is advantageous if the third guide part is preferably L-shaped in cross-section, and a flowing, round-shaped transition is formed between the straight legs of the L-shape to deflect the flow of the coolant from the radial direction into the axial direction so that an axial end face of the winding heads and/or an outer jacket surface of the winding heads can be cooled.

The third guide part advantageously extends in the radial direction from the shaft to an outer jacket surface of the winding heads and ends in the axial direction at the stator.

It is also advantageous if a first coolant guide and a second coolant guide of the cooling device are arranged one after the other in the axial direction.

It is also advantageous if the cooling device has two or more passages which are arranged one after the other in the axial direction.

Preferably, a first passage supplies the first coolant guide with coolant and a second passage supplies the second coolant guide with coolant.

It is also preferred if the first passage supplies a first cooling chamber with coolant and the second passage preferably supplies a second cooling chamber with coolant.

Furthermore, it can be provided that the first coolant guide and/or the second coolant guide is fastened to the stator.

The first coolant guide is advantageously fastened to the second coolant guide.

The concept presented above will be further described in other words below.

This idea preferably relates—to put it simply—to a cooling solution for an electric machine, in which the focus is preferably on the efficient cooling of the winding heads in particular.

In addition to the high efficiency in operation, the cooling solution presented should preferably also be cost-effective in production.

The principle is preferably applicable to an electric machine with a shaft winding, but can also be adapted to other types of electric machines.

The principle is preferably one of indirect cooling, in which the cooling medium or a coolant flows through a hollow shaft of the rotor of the electric machine and second passages are flung through openings or passages.

These openings or passages can be designed as nozzles; but they can also have any shape. The coolant flung out or sprayed out then preferably hits the winding heads or the stator windings in a targeted manner and cools them.

### BRIEF DESCRIPTION OF THE DRAWINGS

The disclosure will be explained in more detail below using an exemplary embodiment in conjunction with an associated drawing. The FIGURE schematically shows the following:

FIG. 1 shows a sectional view of an electric machine according to the disclosure with a cooling device.

### DETAILED DESCRIPTION

In the description below, the same reference signs will be used for the same components.

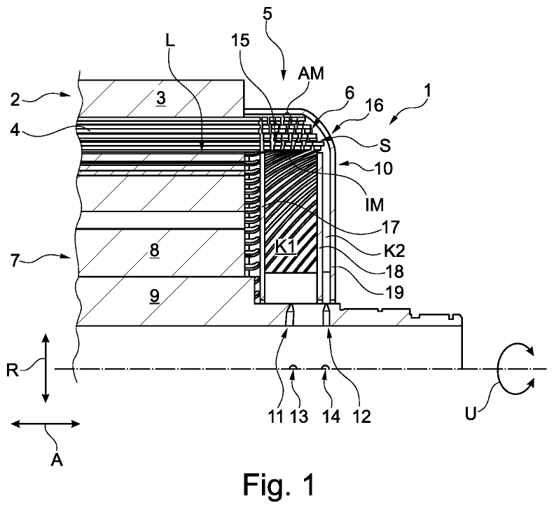

FIG. 1 shows a sectional view of an electric machine 1 according to the disclosure with a cooling device 10.

In more detail, FIG. 1 shows an electric machine 1 with a stator 2, which has a laminated core 3 with windings 4.

At the axial ends 5 of the laminated core 3, a respective winding head 6, formed by the windings 4, protrudes beyond the laminated core 3 in the axial direction A.

Furthermore, the electric machine 1 has a rotor 7 which is rotatably mounted in the stator 2, the rotor 7 comprising a rotor body 8 and a shaft 9 on which the rotor body 8 is fastened.

As already mentioned, the electric machine 1 also comprises a cooling device 10 for cooling the electric machine 1 by means of a coolant.

Here, the cooling device 10 is configured to convey the coolant from the shaft 9 in the direction of the winding heads 6 and thus to cool the winding heads 6.

More precisely, the cooling device 10 is configured to fling or spray the coolant from the shaft 9 in the direction of the winding heads 6 in order to cool the winding heads 6.

Furthermore—roughly described—the cooling device 10 is configured to spray/fling the coolant in the radial and/or axial direction R, A to the winding heads 6 in order to cool them.

The cooling device 10 comprises the shaft 9, which is designed as a hollow shaft for conveying coolant, the cooling device 10 having various passages 11, 12, 13, 14 in the wall of the shaft 9. Thus, coolant can be conveyed from the interior of the shaft 9 through the wall of the shaft 9.

As shown in FIG. 1, the passages 11-14 are distributed or offset in the circumferential direction U of the shaft 9, with the passages 11-14 also being arranged one after the other in the axial direction A.

It can also be seen in FIG. 1 that the passages 11-14 are designed as a nozzle in the wall of the shaft 9. In this way, a spray mist can be created which exchanges heat on the largest possible surface area of the winding heads 6 in order to cool them. The largest possible cooling surface for the coolant can thus also be generated.

It is also shown that the passage 11 is oriented in the axial direction A in the wall of the shaft 9. In other words, the passage 11 is inclined in the radial direction R.

Furthermore, FIG. 1 shows that the cooling device 10 has two coolant guides 15, 16, which guide the coolant from the shaft 9 to the winding heads 6 in the radial direction R and in the axial direction A.

The first coolant guide 15 of the cooling device 10 guides the coolant in the radial direction R from the shaft 9 to the winding heads 6, whereas the second coolant guide 16 of the cooling device 10 supplies the coolant from the shaft 9 to the winding heads 6 first in the radial direction R and then in the axial direction A.

The first coolant guide 15 of the cooling device 10 has a first and a second guide part 17, 18, which extend in the radial direction R and guide coolant from the shaft 9 to an inner jacket surface IM of the winding heads 6.

Here, the first and second guide parts 17, 18 run in a straight line from the shaft 9 to the winding heads 6 and are each designed as a sheet metal disc.

As can be seen from FIG. 1, the winding heads 6 form a hollow cylindrical shape at one axial end of the stator 2, the hollow cylindrical shape having an inner IM and an outer jacket surface AM as well as an axial end face S which is directed outwards away from the electric machine 1.

Furthermore, FIG. 1 shows that the first and second guide parts 17, 18 form a first cooling chamber K1, which limits the application of coolant to the winding heads 6.

Here, the first guide part 17 shields the air gap L between rotor 7 and stator 2 in order to prevent the intrusion of coolant into the air gap L.

Furthermore, the first 17 and second guide part 18 extend in the radial direction R from the shaft 9 to the inner jacket surface IM of the winding heads 6, the second guide part 18 terminating in the axial direction A with the axial end of the winding heads 6, so that coolant from the shaft 9 can be guided to the inner jacket surface IM of the winding heads 6.

The second coolant guide 16 of the cooling device 10 has the second and a third guide part 18, 19, the third guide part 19 extending partly in the radial direction R and partly in the axial direction A.

The second and third guide parts 18, 19 now serve to guide coolant from the shaft 9 to an axial end face S of the winding heads 6.

It can also be seen from FIG. 1 that the second and third guide parts 18, 19 form a second cooling chamber K2, which limits the application of coolant to the winding heads 6.

The third guide part 19 is L-shaped in cross section, and a flowing, round-shaped transition is formed between the straight legs of the L-shape. In this way, the flow of the coolant can be deflected from the radial direction R into the axial direction A so that the axial end face S of the winding heads 6 and the outer jacket surface AM of the winding heads 6 can be cooled.

Described more precisely, the third guide part 19 extends in the radial direction R from the shaft 9 to the outer jacket surface AM of the winding heads 6 and ends in the axial direction A at the stator 2.

It can also be seen from FIG. 1 that the first coolant guide 15 and the second coolant guide 16 of the cooling device 10 are arranged one behind the other in the axial direction A.

As mentioned, the cooling device 10 has various passages 11-14, which are arranged one after the other in the axial direction A, the passages 11, 13 supplying the first coolant guide 15 with coolant and the passages 12, 14 supplying the second coolant guide 16 with coolant.

Furthermore, FIG. 1 shows that the first coolant guide 15 and the second coolant guide 16 are fastened to the stator 2.

In the following, FIG. 1 is described again in other words.

In summary, the innovation of the solution presented here compared to previous cooling methods is advantageously a coolant guide or a cooling device with axially offset nozzles or passages 11 to 14.

The cooling device 10 of the electric machine 1 consists essentially of two parts.

The third guide part 19 of the second coolant guide 16 ensures that the radially flung cooling medium or coolant is guided to the outer ends and onto the winding heads 6.

The third guide part 19 effects, through the rounding, a distribution over the winding heads 6 or over their end face S as well as on the radially outer winding surfaces or the outer jacket surface AM.

The second guide part 18 also serves to guide the flung or sprayed cooling medium/coolant onto the winding heads 6, and is intended to prevent the cooling medium from being lost axially in the direction of the rotor 7.

These two guide parts 18, 19 ensure that the maximum amount of coolant is directed to the winding heads 6. For this portion of coolant, passages 11 to 14 or nozzles are used, which are placed offset around the circumference.

The passage 11 is used for cooling the radially inner winding surfaces or the inner jacket surface IM of the winding heads 6. Here, too, the coolant is flung or sprayed radially outwards.

In the solution shown in FIG. 1, four nozzles or passages 11 to 14 are introduced, which are offset by 90° over the circumference.

In order to optimally wet the long windings that occur in shaft winding technology, the passages 11 to 14 are arranged alternately, in the axial direction A, obliquely to the left and right. It is also conceivable to make the nozzles or passages 11 to 14 straight, but to alternately offset the nozzles axially.

The first guide part 10 prevents the coolant from penetrating into the air gap L and thereby reduces efficiency losses due to shearing of the coolant in the air gap L.

The illustrated cooling device 10 can consist of one part. The cooling device can be expanded to include the rotor bearing and could thus replace existing bearing shields in their function.

### LIST OF REFERENCE SYMBOLS

1 Electric machine
2 Stator
3 Laminated core
4 Windings
5 Axial ends
6 Winding head
7 Rotor
8 Rotor body
9 Shaft
10 Cooling device
11 Passage
12 Passage
13 Passage
14 Passage
15 First coolant guide
16 Second coolant guide
17 First guide part
18 Second guide part
19 Third guide part
A Axial direction
R Radial direction
U Circumferential direction
AM outer jacket surface
IM inner jacket surface
S End face
L Air gap
K1 First cooling chamber
K2 Second receiving chamber

1. An electric machine, comprising:
a stator with a laminated core and windings;
a winding head formed by the windings projects at axial ends of the laminated core in an axial direction beyond the laminated core;
a rotor rotatably mounted in the stator;
the rotor comprises a rotor body and a shaft on which the rotor body is fastened;
and a cooling device for cooling the electric machine with a coolant;
wherein the cooling device is configured to convey the coolant from the shaft towards the winding heads to cool the winding heads.

2. The electric machine according to claim 1, wherein the cooling device is configured to spray the coolant from the shaft towards the winding heads in order to cool the winding heads.

3. The electric machine according to claim 1, wherein the cooling device comprises the shaft, which is a hollow shaft for conveying coolant, and the cooling device has at least one passage in a wall of the shaft so that coolant is adapted be conveyed from an interior of the shaft through the wall of the shaft.

4. The electric machine according to claim 1, wherein the cooling device has two or more passages which are at least one of arranged offset in a circumferential direction of the shaft or arranged one after the other in the axial direction.

5. The electric machine according to claim 1, wherein the cooling device has at least one coolant guide which guides the coolant from the shaft in at least one of a radial direction or in the axial direction to the winding heads.

6. The electric machine according to claim 1, wherein the cooling device includes a first coolant guide that comprises a first and a second guide part which extend in a radial direction and guide coolant from the shaft to an inner jacket surface of the winding heads.

7. The electric machine according to claim 6, wherein the first and second guide parts form a first cooling chamber which is configured to limit an application of coolant to the winding heads, the first guide part shields an air gap between rotor and stator in order to prevent intrusion of coolant into the air gap, the first guide part extends in the radial direction from the shaft to the inner jacket surface of the winding heads, and the second guide part terminates in the axial direction with the axial end of the winding heads so that coolant is adapted to be guided from the shaft to the inner jacket surface of the winding heads.

8. The electric machine according to claim 1, wherein the cooling device includes a second coolant guide that comprises a second and a third guide part, which extend partly in a radial direction and partly in the axial direction, and are configured to guide coolant from the shaft to an axial end face of the winding heads.

9. The electric machine according to claim 8, wherein the second and third guide parts form a second cooling chamber which limits an application of coolant to the winding heads, the second guide part extends in the radial direction from the shaft to an inner jacket surface of the winding heads, the third guide part has a L-shaped cross-section, and a round-shaped transition is formed between straight legs of the L-shape to deflect a flow of the coolant from the radial direction into the axial direction so that at least one of an axial end face of the winding heads or an outer jacket surface of the winding heads is adapted to be cooled, and the third guide part extends in the radial direction from the shaft to the outer jacket surface of the winding heads and ends in the axial direction at the stator.

10. The electric machine according to claim 1, wherein a first coolant guide and a second coolant guide arranged one after the other in the axial direction, the cooling device has two or more passages arranged one after the other in the axial direction, a first one of the passages is configured to supply the first coolant guide with coolant and a second one of the passages is configured to supply the second coolant guide with coolant.

11. The electric machine according to claim 1, wherein the cooling device is configured to guide or spray the coolant in at least one of a radial or an axial direction to the winding heads in order to cool them.

12. The electric machine according to claim 3, wherein the at least one passage is configured to generate a spray mist.

13. The electric machine according to claim 4, wherein the at least one passage comprises a nozzle in a wall of the shaft.

14. The electric machine according to claim 4, wherein the at least one passage is oriented in at least one of a radial or the axial direction in a wall of the shaft.

15. The electric machine according to claim 5, wherein the at least one coolant guide comprises a first coolant guide that guides the coolant from the shaft in the radial direction to the winding heads, and a second coolant guide that guides the coolant from the shaft first in the radial direction and then in the axial direction to the winding heads.

16. The electric machine according to claim 6, wherein the first and second guide parts run in a straight line from the shaft to the winding heads, and each comprise sheet metal disc.

17. The electric machine according to claim 8, wherein the second guide part runs in a straight line from the shaft to the winding heads, and comprises a sheet metal disc, and the second guide part terminates in the axial direction with the axial end of the winding heads so that coolant is adapted to be guided from the shaft to the axial end face of the winding heads.

18. The electric machine according to claim 10, wherein at least one of the first coolant guide or the second coolant guide is fastened to the stator, and the first coolant guide is fastened to the second coolant guide.

19. An electric machine, comprising:
a stator with a laminated core and windings;
a winding head formed by the windings projects at axial ends of the laminated core in an axial direction beyond the laminated core;
a rotor rotatably mounted in the stator;
the rotor comprises a rotor body and a shaft on which the rotor body is fastened; and
a cooling arrangement configured to convey the coolant from the shaft towards the winding heads, the cooling arrangement including the shaft comprising a hollow shaft, and two or more passages in fluid communication with a hollow interior of the shaft which are at least one of arranged offset in a circumferential direction of the shaft or arranged one after the other in the axial direction.

20. The electric machine according to claim 19, wherein the cooling arrangement includes first and second guide parts that form a first cooling chamber which is configured to limit an application of coolant to the winding heads, and the first guide part shields an air gap between rotor and stator in order to prevent intrusion of coolant into the air gap.
